(19) United States
(12) Patent Application Publication
(10) Pub. No.: US 2026/0367876 A1
(43) Pub. Date: Nov. 19, 2026

(54) CONTROLLING THE USE OF SOURCE CODE FOR TRAINING ARTIFICIAL INTELLIGENCE (AI) ALGORITHMS

(71) Applicant: Micro Focus LLC, Santa Clara, CA (US)

(72) Inventors: Carl Emil Orm Wareus, Malmo (SE); Stephan Fong-Jau Jou, Richmond (CA); Alexander Michael Hoole, Vancouver (CA); Michael F. Angelo, Provo, UT (US); Douglas Max Grover, Rigby, ID (US)

(21) Appl. No.: 19/673,815

(22) Filed: May 11, 2026

Related U.S. Application Data
(63) Continuation of application No. 18/520,863, filed on Nov. 28, 2023, now abandoned.

(51) Int. Cl. G06F 8/30

(52) U.S. Cl. CPC G06F 8/30

(57) ABSTRACT

Input source code is retrieved. The input source code is subject to one or more licenses. For example, input source code subject to the MIT and GPL V2 open-source licenses may be retrieved from an open-source repository. A code generation Artificial Intelligence (AI) algorithm is trained using the input source code. The trained code generation AI algorithm is executed to produce output source code. For example, a set of parameters that define the output source code may be provided as input to execute the code generation AI algorithm. One or more licenses associated with the output source code are identified. For example, a vector-based AI algorithm may be used to identify the one or more licenses. The one or more licenses are associated with the output source code. This allows for proper licensing and attribution of the output source code.

### CROSS REFERENCE TO RELATED APPLICATION

The present application is a continuation of U.S. Patent Application No. 18/520,863, filed November 28, 2023, entitled "CONTROLLING THE USE OF SOURCE CODE FOR TRAINING ARTIFICIAL INTELLIGENCE (AI) ALGORITHMS", which is incorporated herein by this reference in its entirety.

The disclosure relates generally to software development and particularly to identifying what types of source code are used in software generated using an AI algorithm.

### BACKGROUND

Artificial Intelligence (AI) Algorithms are now being used to generate source code. One key issue for AI generated source code is to determine which sources of code the actual generated source code derived from. Typically, AI algorithms that generate source code use Large Language Models (LLMs). Because LLMs are trained on incredibly large amounts of source code and because the LLMs may have thousands of layers, it is not currently feasible to use the layers in the LLMs to identify which sources of input source code were actually used to generate the output source code from the AI algorithm.

These and other needs are addressed by the various embodiments and configurations of the present disclosure. The present disclosure can provide a number of advantages depending on the particular configuration. These and other advantages will be apparent from the disclosure contained herein.

Input source code is retrieved. The input source code is subject to one or more licenses. For example, input source code subject to the MIT and GPL V2 open-source licenses may be retrieved from an open-source repository. A code generation Artificial Intelligence (AI) algorithm is trained using the input source code. The trained code generation AI algorithm is executed to produce output source code. For example, a set of parameters that define the output source code may be provided as input to execute the code generation AI algorithm. One or more licenses associated with the output source code are identified. For example, a vector-based AI algorithm may be used to identify the one or more licenses. The one or more licenses are associated with the output source code. This allows for proper licensing and attribution of the output source code.

The phrases "at least one", "one or more", “or,” and "and/or" are open-ended expressions that are both conjunctive and disjunctive in operation. For example, each of the expressions "at least one of A, B and C", "at least one of A, B, or C", "one or more of A, B, and C", "one or more of A, B, or C", "A, B, and/or C", and "A, B, or C" means A alone, B alone, C alone, A and B together, A and C together, B and C together, or A, B and C together.

The term "a" or "an" entity refers to one or more of that entity. As such, the terms "a" (or "an"), "one or more" and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As defined herein and in the claims, the term “license” may include, but does not have to, any type of software/firmware licenses, such as a proprietary software license, a third-party software license, a firmware license, an open-source license, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for controlling the use of open-source code for training a code generation Artificial Intelligence (AI) algorithm.

FIG. 2 is a block diagram of a second illustrative system that shows a flow for controlling the use of open-source code for training a code generation AI algorithm.

FIG. 3 is a flow diagram of a process for identifying open-source licenses that are subject to output source code generated by an AI algorithm.

FIG. 4 is a flow diagram of a process for identifying open-source licenses that are subject to source code generated by a code generation AI algorithm by comparing snippets of code.

FIG. 5 is a flow diagram of a process for identifying open-source licenses that are subject to output source code generated by a code generation AI algorithm by comparing hashes of snippets of code.

FIG. 6 is a flow diagram of a process for identifying open-source licenses that are subject to output source code generated by a code generation AI algorithm by using a vector-based AI algorithm.

FIG. 7 is a flow diagram of a process for identifying repositories of open-source code and filtering out incompatible source code associated with selected incompatible licensees.

FIG. 8 is a flow diagram of a process for determining similarities between output source code and source code not used to train the code generation AI model.

FIG. 9 is diagram of a graphical user interface for filtering out source code used to train an AI algorithm based on selected open-source licenses.

FIG. 10 is a diagram of a graphical user interface for determining a likelihood of which open-source licenses are used in the generation of source code by an AI algorithm based on a user defined threshold.

FIG. 11 is a diagram of a graphical user interface for selecting which incompatible open-source licenses to use when training an AI algorithm.

FIG. 12 is a flow diagram of a process for identifying open-source licenses that are subject to source code generated by a code generation AI algorithm by identifying all the open-source licenses associated with the input source code.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

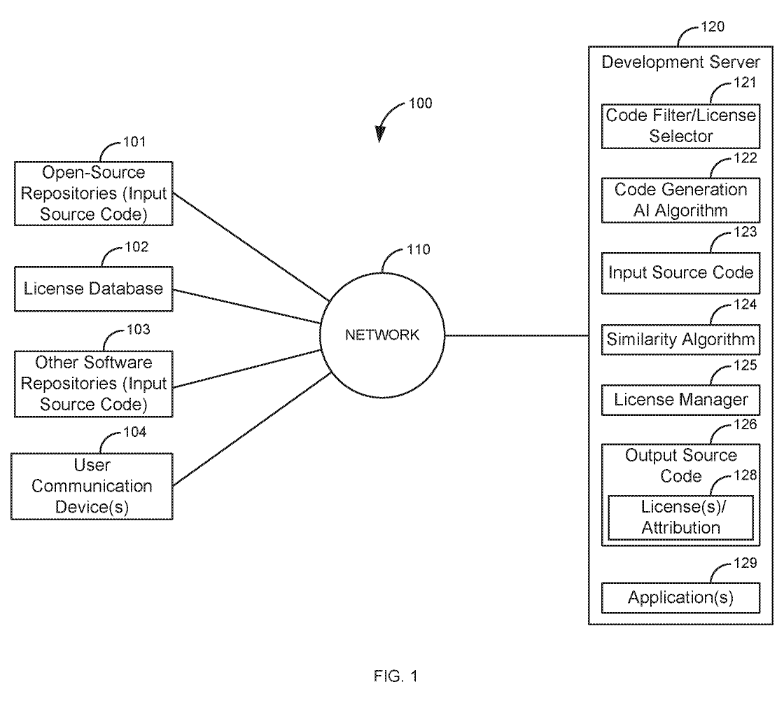

FIG. 1 is a block diagram of a first illustrative system 100 or controlling the use of open-source code for training a code generation Artificial Intelligence (AI) algorithm 122. The first illustrative system 100 comprises an open-source repository 101, a license database 102, other software repositories 103, user communication device(s) 104, a network 110, and a development server 120.

The open-source repositories 101 can be any type of repository where open-source code is stored, such as GitHub, Google Code, Sourceforge, java.net, Freecode, Apache Software Foundation projects, and/or the like. The open-source repositories 101 are shown on the network 110. However, the open-source repositories 101 may reside in the development server 120 and/or on the network 110. The source code in the open-source repositories 101/other software repositories 103 may contain input source code 123 used to train the code generation AI algorithm 122.

The license database 102 may be any database that has the licenses associated with source code. The license database 102 may include proprietary licenses, third-party licenses, open-source licenses, and/or the like. In one embodiment, the licenses may be included as part of the source code. For example, an open-source license may be part of the open-source code as comments. In one embodiment, the license database 102 may be in the development server 120.

The other software repositories 103 may be any repository that stores source code. The source code in the other software repositories 103 may be third-party source code, proprietary source code, and/or the like. The source code in the other software repositories 103 may also be input source code 123 to the code generation AI algorithm 122. The other software repositories 103 may reside on the development server 120 and/or on the network 110.

The user communication device(s) 104 can be or may include any user device that can communicate on the network 110, such as a Personal Computer (PC), a Personal Digital Assistant (PDA), a tablet device, a notebook device, a smartphone, and/or the like. As shown in FIG. 1, any number of user communication devices 104 may be connected to the network 110, including only a single user communication device 104. The user communication device(s) 104 are used by software developers to create new software application(s) 129/source code.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The development server 120 may be any hardware coupled with software that is used to manage the development process of creating software application(s) 129 using source code. The development server 120 may be a user communication device 104 or another device used to manage the development process. For example, the development server 120 may be a local workstation, a laptop, a tablet, and/or the like where a developer is generating the output source code 126 (e.g., in an integrated development environment). The development server 120 further comprises a code filter/license selector 121, a code generation AI algorithm 122, input source code 123, a similarity algorithm 124, a license manager 125, output source code 126, and application(s) 129.

The code filter/license selector 121 is used by the developer to select the repositories 101/103/directories/files and filter out specific input source code 123 for training the code generation AI algorithm 122 based on a particular type of license(s). For example, the developer may decide to filter out any input software that is subject to the Sleepycat open-source license.

The code generation AI algorithm 122 is used to generate the output source code 126. The code generation AI algorithm 122 is trained using the input source code 123 and then generates the output source code 126 based on the developer’s definition of what the output source code 126 is supposed to do.

The input source code 123 can be any type of input source code 123, such as, open-source code, proprietary source code, third-party source code, and/or the like. The input source code 123 may be in the same programming language (e.g., all Java source code). Alternatively, the input source code 123 may be in different types of programming languages, such as, Java, C, C++, C#, Pearl, JavaScript, and/or the like. The input source code 123 may reside in the development server 120, on the user communication device(s) 104, in the repositories 101/103, and/or the like.

The similarity algorithm 124 can be or may include any algorithm coupled with hardware that can identify similarities between the input source code 123 and the output source code 126. For example, the similarity algorithm 124 may be a vector-based AI model. The similarity algorithm 124 is trained using the input source code 123 to identify similar types of relationships in the input source code 123. The trained similarity algorithm 124 is then used to take the output source code 126 and identify similar source code in the input source code 123. The license manager 125 then uses this information to identify the source licenses/attribution 128 that apply to the output source code 126.

The license manager 125 is used to determine which open-source licenses the output source code 126 is subject to. The license manager 125 may determine the open-source licenses using the similarity algorithm 124 in different ways, such as by comparing snippets, by comparing hashes of snippets, using the similarity algorithm 124, and/or the like.

The license manager 125 may also manage attribution. Attribution is where those who developed the open-source source code (or any type of source code for that matter) require that as part of the open-source license the developers names are properly attributed in the application 129/source code when it is distributed. This may include placing the developer’s names in the output source code 126 and/or within the application 129.

The output source code 126 is any source code that is generated by the code generation AI algorithm 122. The output source code 126 may be in different programming languages. In FIG. 1, the output source code 126 comprises source license(s)/attribution 128. Initially, when the output source code 126 is generated by the code generation AI algorithm 122, the output source code 126 does not comprise the source code license(s)/attribution 128. After the license manager 125 determines the proper source licenses/attribution, the license manager 125 then associates the source license(s)/attribution 128 with the output source code 126.

The application(s) 129 are any software/firmware application(s) 129 (or could be a component) that are developed using the output source code 126. The application(s) 129 may be any type of application, such as a web application, a security application, a word processing application, a financial application, a database application, a record tracking application, a social network application, a video application, an email application, a networked application, and/or the like.

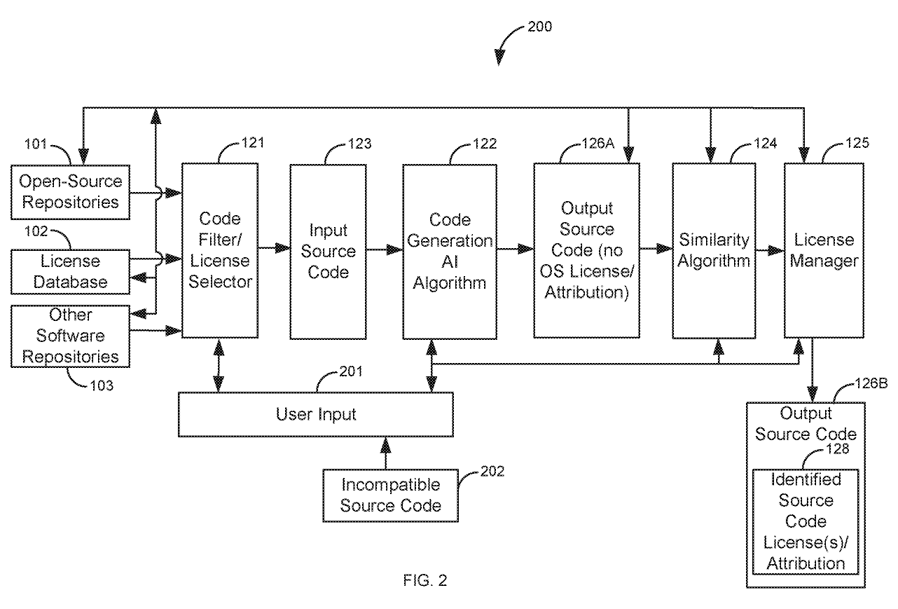

FIG. 2 is a block diagram of a second illustrative system 200 that shows a flow for controlling the use of source code for training a code generation AI algorithm 122. The second illustrative system 200 comprises the open-source repositories 101, the license database 102, the other software repositories 103, the code filter/license selector 121, the code generation AI algorithm 122, the input source code 123, the output source code 126A/126B, the similarity algorithm 124, the license manager 125, and user input 201.

The open-source repositories 101(input source code 123), the license database 102, and the other software repositories 103 (input source code 123) are input into the code filter/license selector 121. The user (e.g., a developer) can then select which repositories 101/103/directories/files and which specific open-source licenses to use for the input source code 123. The code filter/license selector 121 then filters out unwanted source code based on the user’s input.

The code generation AI algorithm 122 is then trained using the input source code 123. The code generation AI algorithm 122 typically uses a Large Language Model (LLM). The LLM typically uses an exceptionally large amount of source code in the training process. Because of the exceptionally large amount of source code used in the LLM training process, it is extremely difficult to identify which input source code 123 is actually being used to generate the output source code 126. This is because a LLM may have thousands of layers that are used to generate the output source code 126. As a result, the identification of the actual open-source licenses used to generate the output source code 126 are difficult to identify.

One of the issues with using the code generation AI algorithm 122 to generate the output source code 126 is that the input source code 123 used to train the AI model may have different open-source license requirements. For example, the input source code 123 that is used to train the code generation AI algorithm 122 may be subject to restrictive open-source licenses, such as, Aferro GPL, GPL, LGPL, Sleepycat, and/or the like. As a result, any generated source code may also be subject to the same restrictive licenses. This can result in unwittingly contaminating proprietary software code bases when the output source code 126 generated by the code generation AI algorithm 122 is integrated with proprietary software.

After the code generation AI algorithm 122 is trained, the user/system requests to create a specific type of output source code 126. For example, the user may request that the trained code generation AI algorithm 122 create a web site that is used to sell a specific type of product, that it has a cart where the user can select and add products to purchase and then checkout using a credit card process where the credit card transaction is encrypted using 256 bit DES encryption. In addition, the user may provide source code as part of the input to the code generation AI algorithm 122 to further guide code generation AI algorithm 122. The result is that the output source code 126A is generated. Initially, the output source code 126A does not have any associated proprietary or open-source license(s)/attribution.

The output source code 126A may be input into the similarity algorithm 124. The similarity algorithm 124 may compare the output source code 126A to source code that was not part of the training process. For example, the training process may not have used the Affero GPL, GPL V2, LGPL, and the Sleepycat licenses. The similarity algorithm 124 may scan source code associated with these licenses from the original open-source repositories (101), other software repositories (103), or user input (201) to identify similarities. If there are similarities, this information can be fed back to the code generation AI algorithm 122. For example, the initial text provided by the user may be added to, such as to not use a particular naming convention, to not use a specific object name and/or type, to not use incompatible source code 202 similar to source code that has been deemed incompatible with excluded licenses by the similarity algorithm 124, and/or the like. The feedback causes the code generation AI algorithm 122 to regenerate the output source code 126A.

If the similarity algorithm 124 is complete, the license manager 125 determines the proprietary or open-source licenses associated with the output source code 126A. For example, the similarity algorithm 124 may compare snippets of code between the input source code 123 and the output source code 126A, may compare hashes of snippets of the input source code 123 and hashes of snippets of the output source code 126A, and/or the like. The result of the comparisons by the similarity algorithm 124 identifies a set of input source files where similarities exist. The license manager 125 then determines all of the licenses used in the input source code 123 are relevant/similar to the generated output code 126A based upon the licenses associated with the set of input source files containing similarities. The license manager 125 then associates the source code license(s)/attribution 128 with the output source code 126B.

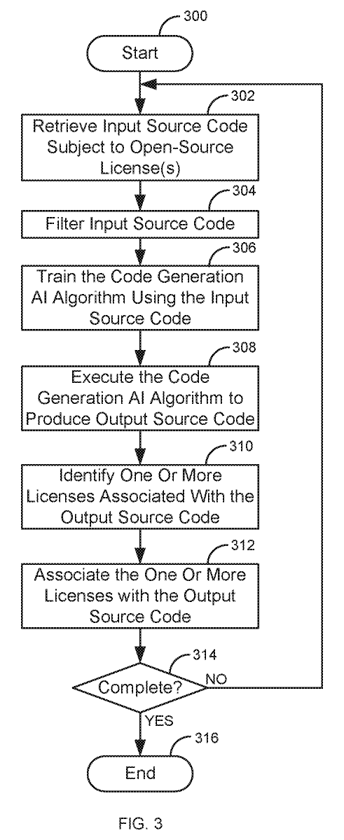

FIG. 3 is a flow diagram of a process for identifying open-source licenses that are subject to output source code 126 generated by a code generation AI algorithm 122. Illustratively, the open-source repositories 101, the license database 102, the other software repositories 103, the user communication device(s) 104, the development server 120, the code filter/license selector 121, the code generation AI algorithm 122, the input source code 123, the similarity algorithm 124, the license manager 125, the output source code 126, and the application(s) 129 are stored-program-controlled entities, such as a computer or microprocessor, which performs the method of FIGS. 3-12 and the processes described herein by executing program instructions stored in a computer readable storage medium, such as a memory (i.e., a computer memory, a hard disk, and/or the like). Although the methods described in FIGS. 3-12 are shown in a specific order, one of skill in the art would recognize that the steps in FIGS. 3-12 may be implemented in different orders and/or be implemented in a multi-threaded environment. Moreover, various steps may be omitted or added based on implementation.

The process starts in step 300. The code generation AI algorithm 122 retrieves the input source code 123 subject to the source licenses in step 302. The code generation AI algorithm 122 may retrieve the input source code 123 in various ways, such as retrieving the input source code 123 from the open-source repository 101, retrieving the input source code 123 locally from the development server 120, retrieving the input source code 123 from the other software repositories 103, and/or the like.

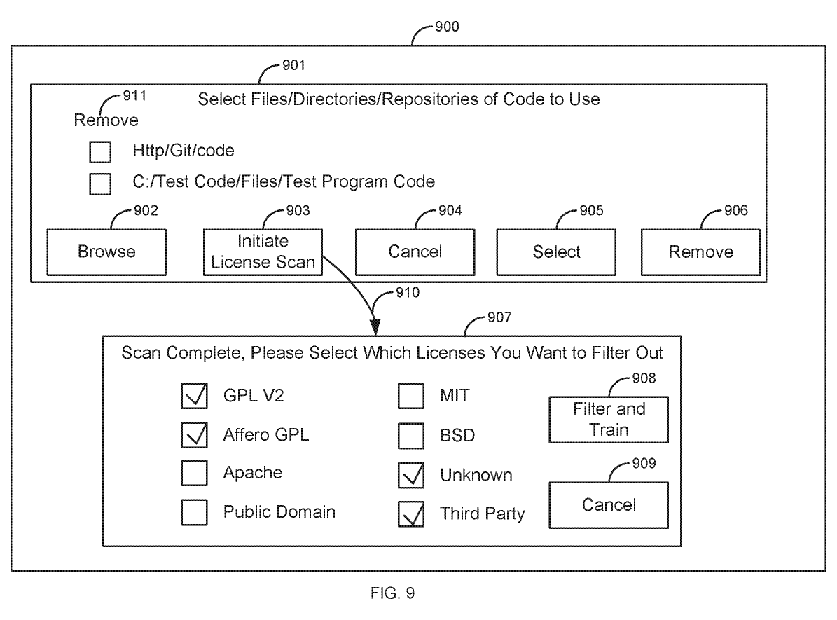

The code filter/license selector 121 filters the input source code 123 in step 304. The filtering may be based on input from a user via a graphical user interface (e.g., as described in FIG. 9). The filtering may be based on a configuration file or some other means. The filtering of step 304 may be optional.

In one embodiment, the filtering of step 304 may be to filter the input source code 123 because it has similarities to unwanted input source code. For example, if the input source code 123 contains a GPL V2 source code file similar to a MIT source code file, the code filter 121 may filter out the MIT source code file as well so the code generation AI algorithm 122 does not generate output source code 126 that is similar to the GPL V2 license. The filtering of step 304 may be based on user input, based on a profile, and/or the like.

The code generation AI model 122 is trained, in step 306, using the input source code 123 that has been filtered (if filtering was used). The code generation AI algorithm 122 is then executed, in step 308, to produce the output source code 126. For example, the code generation AI algorithm 122 may receive input from the user (201) on the specific parameters of the actual source code to be generated. As part of the execution of the AI algorithm in step 308, the input may include input to add additional source code to further refine parameters on what is generated.

The similarity algorithm 124 and license manager 125 identify one or more licenses associated with the output source code 126 that matches input source code in step 310. For example, if there were ten open-source licensees associated with the input source code 123 used to train the code generation AI algorithm 122, the same ten open-source licenses may be identified or a subset thereof (a same license analysis). The license manager 125 then associates the one or more licenses with the output source code 126 in step 312. The license manager 125 may associate the one or more licenses in different ways, such as, by adding the one or more licenses to the output source code 126 (e.g., in comments), by creating an attribution file with the one or more licenses, and/or the like. For example, if there were ten separate classes, each of the ten classes would have the same associated licenses. If the identification of the licenses uses snippets, hashes, and/or vectors, individual classes may have different associated open-source licenses based on the comparison back to the input source code 123.

The processes of step 310-312 may also associate the proper attribution in a similar manner as the licenses. For example, if there were two open-source licenses to add to the output source code 126 where the first open-source license requires attribution to person A and person B and the second open-source license requires attribution to person C and person D, the two open-source licenses would be included along with the proper attribution for the persons A-D.

The process determines, in step 314, if the process is complete. If the process is not complete in step 314, the process goes back to step 302. Otherwise, if the process is complete in step 314, the process ends in step 316.

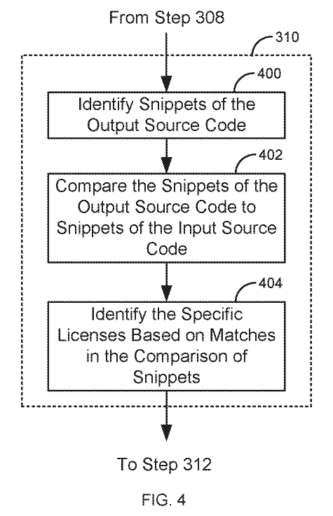

FIG. 4 is a flow diagram of a process for identifying open-source licenses that are subject to the output source code 126 generated by an AI algorithm 122 by comparing snippets of code. The process of FIG. 4 is an exemplary embodiment of step 310 of FIG. 3. After executing the code generation AI algorithm 122 to produce the output source code 126 in step 308, the similarity algorithm 124 identifies snippets of the output source code 126 in step 400. For example, the similarity algorithm 124 may identify the snippets based on individual lines in the output source code 126, based on dividing the output source code 126 into specific numbers of lines of code, by splitting the output source code 126 based on functions and then based on a number of lines, and/or the like.

The similarity algorithm 124 compares the snippets of the output source code 126 to similar snippets of the input source code 123, derived from open-source repositories 101 and other software repositories 103 that satisfy code filtering/license selector 121, and source code from user input 201 in step 402. For example, the similarity algorithm 124 may compare the snippets that are of the same size between the input source code 123 and the output source code 126.

In one embodiment, if there are matches in the comparison of the snippets, by the similarity algorithm 124, then the license manager 125 identifies the specific licenses in step 404. The comparison may be based on a threshold. For example, if a match is made to an input source code 123 associated with a BSD license, the BSD license will be identified based on the match in step 404. The process then goes to step 312.

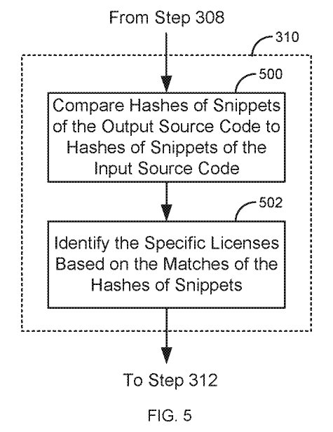

FIG. 5 is a flow diagram of a process for identifying open-source licenses that are subject to the output source code 126 generated by the code generation AI algorithm 122 by comparing hashes of snippets of code. The process of FIG. 5 is an exemplary embodiment of step 310 of FIG. 3. After executing the code generation AI algorithm 122 to produce the output source code 126 in step 308, the similarity algorithm 124 compares hashes of snippets of the output source code 126 to hashes of snippets of the input source code 123 in step 500. The process of determining snippets may be similar to those discussed in FIG. 4.

The similarity algorithm identifies the specific files from the input source code 123 based on matches of the hashes of the snippets in step 502. The license manager 125 then determines the license associated with the input source file. For example, if hashes of a snippets of the output source code 126 matches hashes of a snippets of the input source code 123 that is associated with the BSD open-source license and the MIT open-source license, the BSD open-source license and the MIT open-source license will be identified in step 502. The process then goes to step 312.

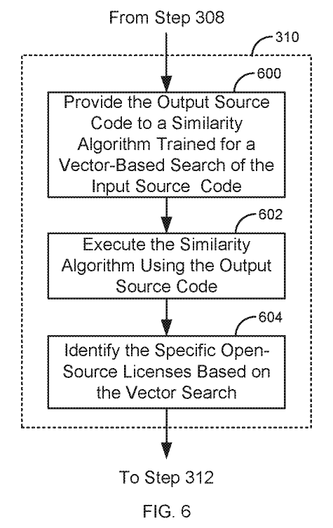

FIG. 6 is a flow diagram of a process for identifying open-source licenses that are subject to output source code 126 generated by the code generation AI algorithm 122 using the similarity algorithm 124. The process of FIG. 6 is an exemplary embodiment of step 310 of FIG. 3. After executing the code generation AI algorithm 122 to produce the output source code 126A in step 308, the code generation AI algorithm 122 provides the output source code 126A to the similarity algorithm 124 in step 600.

The similarity algorithm 124, which has been trained on the input source code 123, is executed using the output source code 126A in step 602 to instigate a vector-based comparison between the input source code 123 and the output source code 126. The similarity algorithm 124, in one embodiment, may be aware of coding constructs. For example, if a snippet is identical, but all the variable names have changed or the use of unimportant white space is used, this will still result in a 100% similarity. A vector-based search converts the output source code 126 into floating vector points. The output source code vectors have a semantic meaning for similar types of relationships. For example, similar types of objects or methods will have similar floating vector points. Thus, they will have a similar distance when comparing the vectors for the output source code 126 to the vectors for the input source code 123. Thus, similarities in the output source code 126 can be efficiently identified based on the training set (the input source code 123) to identify specific pieces of input source code 123 that have been used to generate the output source code 126.

Based on the identified input source code 123, the license manager 125 identifies the specific open-source licenses, based on the output from the vector search in step 604. For example, if the identified input source code 123 is based on an LGPL 1.0 license, the LGPL 1.0 license will be identified in step 604. The process of step 604 may use a threshold. If the likelihood is above the threshold, the license will be identified. The process then goes to step 312.

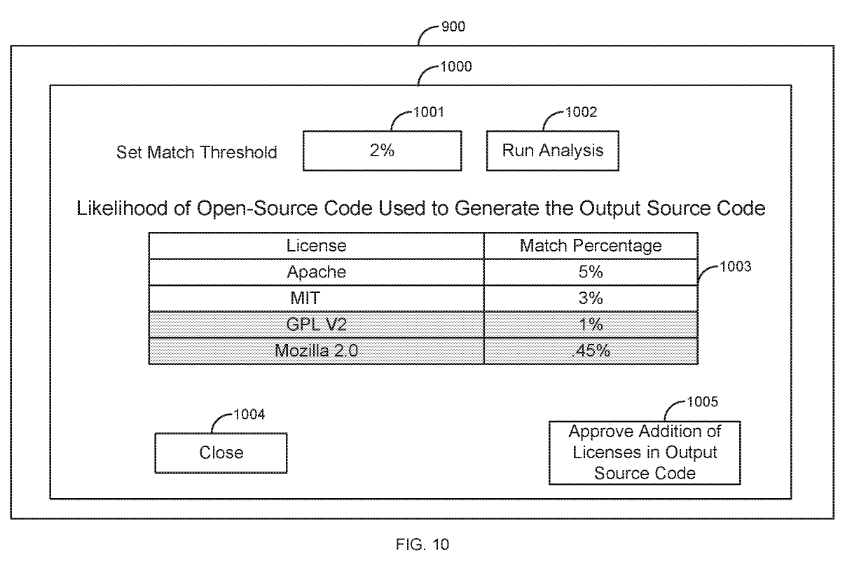

The process of step 604 may include the identification of multiple licenses of the same type in different components of the input source code 123. For example, if there are multiple matches of the same open-source license to multiple components of the input source code, the matching percentage for that license is a combination of the matches for the multiple components (e.g., as described in FIG. 10). The output generated by step 604 may also include other metrics, such as a saturation metric, a confidence metric, and other potential mixes of multiple training inputs. For example, if the output of the vector search identifies a combination of multiple components, a confidence metric of the combined licenses may be identified. The processes of identifying multiple licenses of the same type and combinations of multiple components described above can also be applied to FIGS. 4-5.

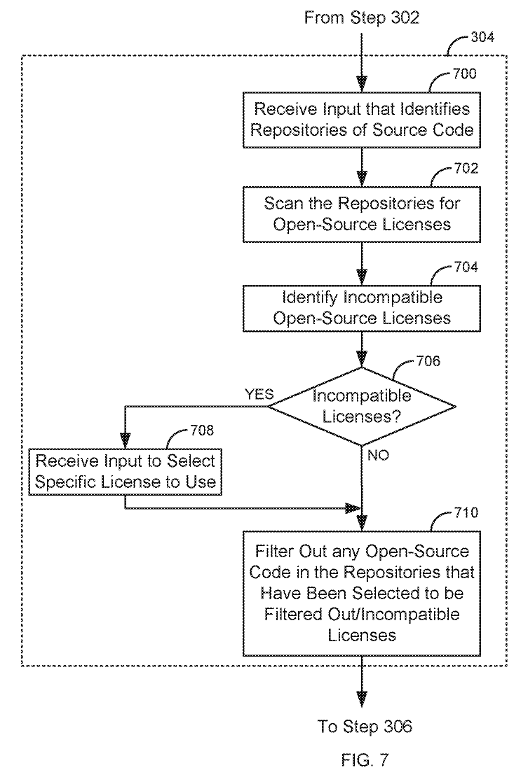

FIG. 7 is a flow diagram of a process for identifying repositories of open-source code and filtering out incompatible source code associated with selected incompatible licensees. FIG. 7 is an exemplary embodiment of step 304 of FIG. 3.

After getting the input source code 123 in step 302, the code filter/license selector 121 receives input that identifies the repositories of the source code (e.g., the repositories 101/103) in step 700. The code filter/license selector 121 scans the repositories 101/103 for open-source licenses in step 702. The code filter/license selector 121 identifies any incompatible open-source licenses in step 704.

If there are not any incompatible licenses in step 706, the process goes to step 710. Otherwise, if there are incompatible licenses in step 706, the code filter/license selector 121 receives user input 201, in step 704, to select which of the incompatible licenses are to be used in step 708. The code filter/license selector 121 then filters out any open-source code in the repositories 101/103 that have been selected to be filtered out and the incompatible licenses that have also been selected to be filtered out in step 710. The process then goes to step 306.

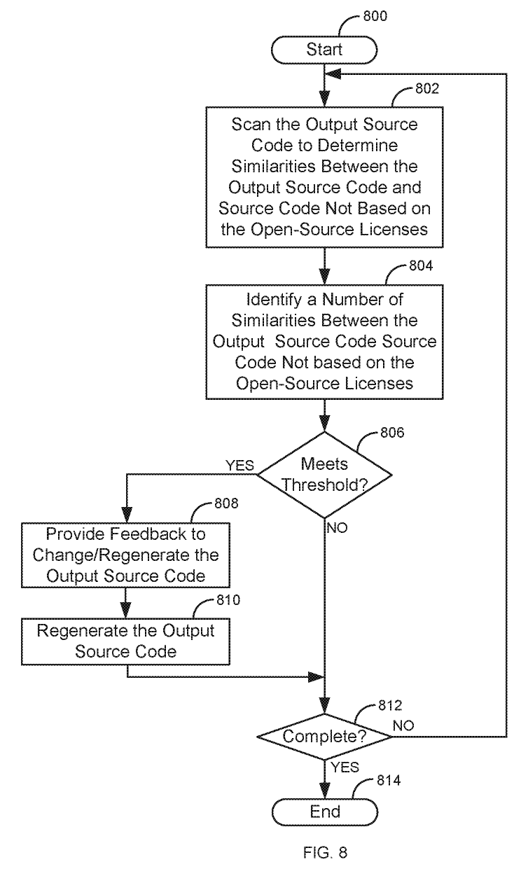

FIG. 8 is a flow diagram of a process for determining similarities between output source code 126 and source code not used to train the code generation AI model 122. The process starts in step 800. The similarity algorithm 124 scans the output source code 126 to determine similarities between the output source code 126 and source code not based on the selected open-source licenses in step 802 (e.g., those open-source licenses that were filtered out in step 304). For example, if the user selected to not use any GPL/LGPL source code (an undesirable type of open-source code) in the open-source repositories 101 for training the code generation AI algorithm 122, the similarity algorithm 124 can compare the output source code 126 to the undesirable open-source code that has any GPL/LGPL licenses in the open-source repositories 101.

The similarity algorithm 124 identifies a number of similarities between the output source code 126 and the source code not based on the open-source licenses in step 804. The similarities may use snippets, hashes of snippets, vector-based comparisons, and/or the like (e.g., like described in FIGS. 4-6). The similarities may be based on a similarity threshold. For example, the threshold may be a learned threshold, a user defined threshold, and/or the like. If the similarities do not meet the similarity threshold step 806 (e.g., the threshold has not been met), the process goes to step 812.

Otherwise, if the similarities meet the similarity threshold in step 806, the similarity algorithm 124 provides feedback to change/regenerate the output source code 126 in step 808. For example, if there are similarities, the similarity algorithm 124 can indicate ways to change the output source code 126, such as redefining the input parameters on how the code generation AI algorithm 122 generates the output source code 126. In addition, a user could provide the feedback in step 808. The code generation AI algorithm 122 regenerates, in step 810, the output source code 126 and then goes to step 812.

The similarity algorithm 124 determines, in step 812, if the process is complete. If the process is not complete in step 812, the process goes back to step 802. Otherwise, if the process is complete in step 812, the process ends in step 814.

FIG. 9 is diagram of a graphical user interface 900 for filtering out source code used to train the code generation AI algorithm 122 based on selected open-source licenses. The graphical user interface 900 comprises a select directory/repository window 901 and a select open-source license window 907.

The select directory/repository window 901 comprises a browse button 902, an initiate license scan button 903, a cancel button 904, a select button 905, a remove button 906, and a remove column. The select directory/repository window 901 allows a user to identify a location (e.g., the open-source repository 101/other software repositories 103). Once a location is identified, the user can then click on the select button 905 to add a directory/file/repository 101/103 to the select directory/repository window 901. If the user wants to remove a directory/repository 101/103 the user can select the remove button 906 (e.g., by checking a corresponding remove checkbox in the remove column). If the user wants to browse for a directory/repository 101/103, the user can select the browse button 902.

Once the user has selected the directories/repositories 101/103, the user can then click on the initiate license scan button 903. This causes the code filter/license selector 121 to scan the selected directories/repositories 101/103, in step 910, to identify which source code has an associated open-source license or any type of license. The open-source licenses are typically in the specific source code file. Once the open-source licenses/other licenses are identified in step 910, the select open-source license window 907 is displayed in the graphical user interface 900.

The select open-source license window 907 allows the user to select individual open-source licenses that the user wants filtered out from the training process of the code generation AI algorithm 122. In FIG. 9, the code filter/license selector 121 has identified eight types of licenses: 1) GPL V2, 2) Affero GPL, 3) Apache, 4) Public Domain, 5) MIT, 6) BSD, 7) Unknown, and 8) third-party. In FIG. 9, the user has selected to filter out any source code subject to the GPL V2, Affero GPL, Unknown, and Third-Party licenses.

Once the user has selected what open-source licenses are to be used to filter out source code from the selected repositories 101/103, the user can then select the filter and train button 908 to train the code generation AI algorithm 122. As a result, when the code generation AI algorithm 122 generates the output source code 126, the user can control what open-source licenses the output source code 126 is subject to. This allows a user to filter out any open-source licenses that may cause unwanted infection of proprietary source code. Another option would be where the user could just select a single license, thus making the output source code 126 subject to the same open-source license. If the user does not want to filter and train, the user can select the cancel button 909.

FIG. 10 is a diagram of a graphical user interface 900 for determining a likelihood of which open-source licenses are used in the generation of source code by the code generation AI algorithm 122 based on a user defined threshold. In FIG. 10, the graphical use interface 900 comprises a likelihood window 1000. The likelihood window 1000 comprises a match threshold field 1001, a run analysis button 1002, an open-source license threshold list 1003, a close button 1004, and an approve addition of licenses in output source code button 1005.

Initially, the likelihood window 1000 only displays that the match threshold field 1001, the run analysis button 1002, and the close button 1004 are active. The user then selects the run analysis button 1002 to initiate the process of identifying one or more open-source licenses (or could be any type of license) associated with the generated source code 126 (e.g., using the processes described in FIGS. 4-6). As a result of the analysis, the threshold list 1003 is displayed and the approve addition of licenses in output source code button 1005 becomes active.

The threshold list 1003 shows the results of the analysis. The match percentages in the threshold list 103 are based on how much source code in the generated source code 126 matches or is similar to source code used to train the code generation AI algorithm. The threshold list 1003 shows the match percentage of each of the identified open-source licenses being used by the code generation AI algorithm 122 to generate the output source code 126. In FIG. 10, there are four open-source licenses identified along with a match percentage. The Apache open-source license has a 5% match, the MIT open-source license has a 3% match, the GPL V2 open-source license has a 1% match, and the Mozilla 2.0 open-source license has a .45% match. Normally, the total of the match percentages will be below 100%. However, the total match percentage may be above 100% if there are matches of same source code in source code of multiple open-source licenses.

In FIG. 10, the user has set the match threshold field 1001 to be at 2%. This is reflected in the threshold list 1003 where the GPL V2 open-source license and the Mozilla 2.0 open-source license are greyed out, which indicates that they are both below the match threshold 1001. If the user changed the match threshold 1001 to 1%, then the GPL V2 open-source license would no longer be greyed out because it is above the 1% match threshold 1001.

Once the user has decided on a match threshold 1001, the user can then click on the approve addition of licenses in output source code button 1005. This causes the open-source licenses (Apache and MIT) to be added to the output source code 126. Although not shown, the user could elect to save the licenses to a file. This process could even apply to proprietary software where the generated source code has similar copyright information placed in the headers. For example, if the headers of the proprietary software had a copyright notice (e.g., copyright opentext® 2023) a similar copyright notice can be placed in the newly generated output source code 126.

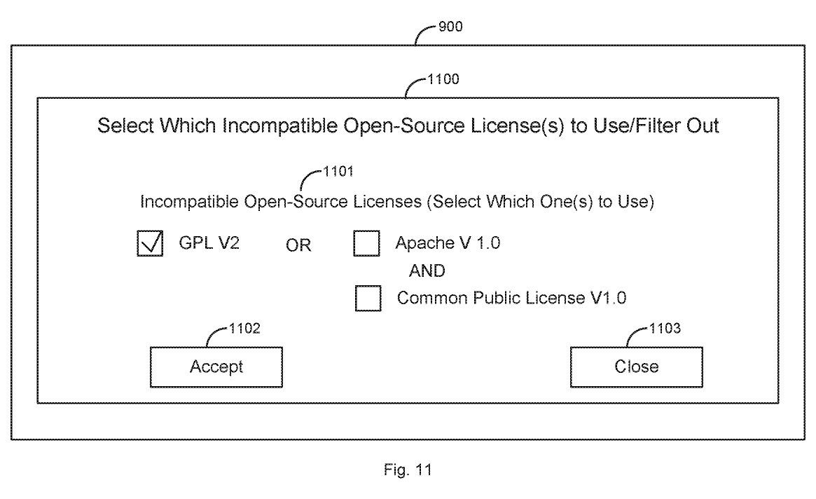

FIG. 11 is a diagram of a graphical user interface 900 for selecting which incompatible open-source licenses to use when training the code generation AI algorithm 122. The graphical user interface 900 comprises an incompatible license window 1100. The incompatible license window 1100 comprises a selection area 1101, an accept button 1102, and a close button 1103.

When the open-source code that is used to train the code generation AI algorithm 122 is identified, the license manager 125 determines which open-source licenses are incompatible. The incompatibility may be determined based on predefined rules that define the incompatibilities, based on user input, and/or the like. In FIG. 11, the incompatibilities are between the GPL V2 open-source license and the Apache 1.0/Common Public License 1.0 open-source licenses. In this example, the Apache 1.0 and the Common Public License 1.0 are both not compatible with the GPL V.2 open-source license. However, the Apache 1.0 open-source license and the Common Public License 1.0 are compatible (indicated by the AND) with each other.

In FIG. 11, the user has selected to filter out the GPL V2 open-source license. Although only one incompatibility has been shown in FIG. 11, multiple incompatibilities may be shown. If the user wants to accept the selected open-source licenses to be filtered, the user can select the accept button 1102. If the user wants to ignore the incompatibilities, the user can select the close button 1103.

The identification of incompatible licenses may apply to any kind of license (e.g., any third-party license). For example, the rules may define that a particular third-party license is incompatible with a particular open-source license.

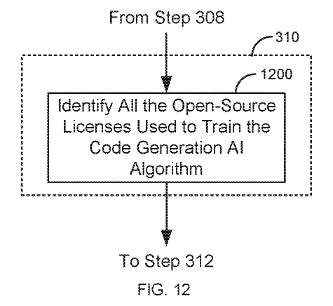

FIG. 12 is a flow diagram of a process for identifying open-source licenses that are subject to source code generated by a code generation AI algorithm 122 by identifying all the open-source licenses associated with the input source code 123. The process of FIG. 12 is an exemplary embodiment of step 310 of FIG. 3. After executing the code generation AI algorithm 122 to produce the output source code 126 in step 308, the license manager 125 identifies all the open-source licenses that are used to train the code generation AI algorithm 122 in step 1200.

In this example, there is a one-to-one relationship between the open-source licenses used to train the code generation AI algorithm 122 and the open-source licenses that are added to the output source code 126. For example, if there were fifteen open-source licenses in the input source code 123 used to train the code generation AI algorithm 122, there would be the same fifteen open-source licenses added to the output source code 126. In this example, the similarity algorithm is not used.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a microprocessor; and
a computer readable medium, coupled with the microprocessor and comprising microprocessor readable and executable instructions that, when executed by the microprocessor, cause the microprocessor to:
retrieve, from a source code repository stored in memory, input source code, wherein the input source code is associated with one or more software licenses stored as a structure metadata in the source code repository;
train a code generation Artificial Intelligence (AI) model using the input source code;
execute the trained code generation AI model to generate output source code;
identify, using a license detection process applied to the generated output source code, one or more software licenses associated with the output source code;
associate the identified one or more software licenses with the output source code by generating and storing license metadata linked to the output source code; and
automatically store the output source code together with the identified one or more software licenses in a repository configured to enforce license compliance constraints for subsequent code execution, distribution and integration.

2. The system of claim 1, wherein the microprocessor readable and executable instructions further cause the microprocessor to:
associate one or more attributions to the output source code.

3. The system of claim 1, wherein the one or more software licenses comprises a plurality of software licenses and wherein identifying the one or more software licenses associated with the output source code is further based on at least one of the following:
comparing snippets of the input source code to snippets of the output source code;
comparing hashes of snippets of the input source code to hashes of snippets of the output source code;
using a vector-based AI model; and
identifying all software licenses associated with the input source code.

4. The system of claim 3, wherein identifying the one or more software licenses associated with the output source code is based on comparing the snippets of the input source code to the snippets of the output source code.

5. The system of claim 3, wherein identifying the one or more software licenses associated with the output source code is based on the comparing of the hashes of snippets of the input source code to the hashes of snippets of the output source code.

6. The system of claim 3, wherein identifying the one or more software licenses associated with the output source code is based on identifying all the software licenses associated with the input source code.

7. The system of claim 3, wherein identifying the one or more software licenses associated with the output source code is based on the vector-based AI model.

8. The system of claim 7, wherein the identified plurality of software licenses are associated with the output source code based on a likelihood threshold.

9. The system of claim 1, wherein the microprocessor readable and executable instructions further cause the microprocessor to:
receive input identifying one or more source code repositories;
receive input specifying one or more software license types to be filtered;
scan the one or more source code repositories to identify source code associated with the one or more specified software license types; and
filter out the identified source code in the identified one or more source code repositories associated with the one or more specified software license types.

10. The system of claim 9 wherein the microprocessor readable and executable instructions further cause the microprocessor to:
determine whether portions of the filtered-out source code are similar to portions of the input source code; and
in response to determining such similarities, refilter the input source code to remove the portions of the input source code that correspond to the similar portions of the filtered-out source code .

11. The system of claim 1, wherein the microprocessor readable and executable instructions further cause the microprocessor to:
scan the output source code to determine similarities between the output source code and source code not governed by the one or more software licenses;
identify a degree of similarities between the input source code and the source code not governed by the one or more software licenses;
in response to determining that the degree of similarity exceeds a predefined similarity threshold, generate feedback for the code generation AI model to modify generation parameters; and
regenerate the output source code based on the generated feedback.

12. The system of claim 1, wherein the one or more software licenses comprise a plurality of software licenses, wherein at least two of the plurality of software licenses are incompatible, and wherein the microprocessor readable and executable instructions further cause the microprocessor to:
generate, for display in a graphical user interface, an indication that identifies the incompatible at least two of the plurality of software licenses ;
receive, via the graphical user interface, user input selecting one of the incompatible software licenses to filter; and
filter out source code associated with the selected incompatible software license.

13. The system of claim 1, wherein the microprocessor readable and executable instructions further cause the microprocessor to:
generate, for display in a graphical user interface, a listing indicating percentages representing similarity matches between t the one or more software licenses and the input source code;
receive, via the graphical user interface, a user-specified similarity threshold; and
associate the one or more software licenses with the output source code based on whether the similarly match satisfy the similarity threshold.

14. The system of claim 1, wherein identifying the one or more software licenses associated with the output source code comprises identifying a specific one of the one or more software licenses from multiple components of the input source code.

15. A method, comprising:
retrieving, by a microprocessor, input source code, wherein the input source code is associated with one or more software licenses stored as a structure metadata in the source code repository;
training, by the microprocessor, a code generation Artificial Intelligence (AI) model using the input source code;
executing, by the microprocessor, the trained code generation AI model to generate output source code;
identifying, using a license detection process applied to the generated output source code, by the microprocessor, one or more software licenses associated with the output source code;
associating, by the microprocessor the identified one or more software licenses with the output source code by generating and storing license metadata linked to the output source code; and
automatically storing, by the microprocessor, the output source code together with the identified one or more software licenses in a repository configured to enforce license compliance constraints for subsequent code execution, distribution and integration.

16. The method of claim 15, wherein the one or more software licenses comprises a plurality of software licenses and wherein identifying the one or more software licenses associated with the output source code is further based on at least one of the following:
comparing snippets of the input source code to snippets of the output source code;
comparing hashes of snippets of the input source code to hashes of snippets of the output source code;
using a vector-based AI model; and
identifying all software licenses associated with the input source code.

17. The method of claim 16, wherein identifying the one or more software licenses associated with the output source code is based on comparing the snippets of the input source code to the snippets of the output source code.

18. The method of claim 16, wherein identifying the one or more software licenses associated with the output source code is based on the comparing of the hashes of snippets of the input source code to the hashes of snippets of the output source code.

19. The method of claim 16, wherein identifying the one or more software licenses associated with the output source code is based on the vector-based AI model.

20. The method of claim 15, further comprising:
scanning the output source code to determine similarities between the output source code and source code not governed by the one or more software licenses;
identifying a degree of similarities between the input source code and the source code not governed by the one or more software licenses;
in response to determining that the degree of similarity exceeds a predefined similarity threshold, generating feedback for the code generation AI model to modify generation parameters; and
regenerating the output source code based on the generated feedback.

21. The method of claim 15, further comprising:
generating, for display in a graphical user interface, a listing indicating percentages of representing similarity matches between the one or more software licenses and the input source code;
receiving, via the graphical user interface, a user-specified similarity threshold; and
associating the one or more software licenses with the output source code based on whether the similarity match satisfy the similarity threshold.

22. A non-transient computer readable medium having stored thereon instructions that cause a processor to execute a method, the method comprising instructions to:
retrieve, from a source code repository, input source code, wherein the input source code is associated with one or more software licenses stored as a structure metadata in the source code repository;
train a code generation Artificial Intelligence (AI) model using the input source code;
execute the trained code generation AI model to generate output source code;
identify, using a license detection process applied to the generated output source code, one or more software licenses associated with the output source code;
associate the identified one or more software licenses with the output source code by generating and storing license metadata linked to the output source code; and
automatically store the output source code together with the identified one or more software licenses in a repository configured to enforce license compliance constraints for subsequent code execution, distribution and integration.
